(19) United States
(12) Patent Application Publication
(10) Pub. No.: US 2022/0112424 A1
(43) Pub. Date: Apr. 14, 2022

(54) FLUIDS FOR HYDRAULIC FRACTURING

(71) Applicant: Advanced BioCatalytics Corporation, Irvine, CA (US)

(72) Inventors: Brigitte Winkler, Irvine, CA (US); Carl W. Podella, Irvine, CA (US); Larry Tung On Co, Lake Forest, CA (US)

(73) Assignee: Advanced BioCatalytics Corporation, Irvine, CA (US)

(21) Appl. No.: 17/560,221

(22) Filed: Dec. 22, 2021

Related U.S. Application Data
(63) Continuation of application No. 16/814,904, filed on Mar. 10, 2020, now abandoned.

(51) Int. Cl. C09K 8/584; C09K 8/18; C09K 8/62; E21B 43/26

(52) U.S. Cl. CPC C09K 8/584; E21B 43/26; C09K 8/62; C09K 8/18

(57) ABSTRACT

Disclosed herein are fluid mixtures comprising a fermentation mixture; a glycol; a non-ionic and/or anionic surfactant; and water, wherein: the fermentation mixture comprises about 10-70% (v/v) of the fluid; the glycol comprises about 1-35% (v/v) of the fluid; and the surfactant comprises about 1-70% (v/v) of the fluid.

### CROSS-REFERENCE TO RELATED APPLICATION

This is a continuation of co-pending U.S. Utility application Ser. No. 16/814,904, filed on Mar. 10, 2020, which is incorporated by reference herein in its entirety.

### FIELD OF THE INVENTION

The present invention is in the field of hydraulic fracturing and in particular in the field of fluids used in hydraulic fracturing.

### BACKGROUND OF THE DISCLOSURE

In hydraulic fracturing, rock in the well is fractured by a pressurized liquid. In many instances, the fluid comprises proppants, sand or small solid material, that can occupy the space created by cracks in the rock, thereby preventing the cracks to reform once the pressurized liquid is removed. Oil, natural gas, ground water, and other material trapped in the rock can then seep out of the cracks and be collected. Frequently other chemical additives are included to enhance the well production, stimulation and flowback of injection water and hydrocarbons.

There is no one-size-fits-all fluid for fracturing. The type of rock and the conditions in the well require the fracturing fluid to be customized for each particular use. Therefore, there is a need in the art for further new fracturing fluids that reflect the variations in reservoir and operating conditions, including injection water chemistry, reservoir oil and water chemistry, lithology and down hole temperature.

### SUMMARY OF THE INVENTION

Disclosed herein are fluid mixture comprising a fermentation mixture; non-ionic and/or anionic surfactant stabilizing agents such as a glycol; and water, wherein: the fermentation mixture comprises about 10-70% (v/v) of the fluid; the glycol comprises about 1-35% (v/v) of the fluid; the surfactant components comprises about 1-50% (v/v) of the fluid; and the water comprises the balance of the mixture. The surfactant component ratios vary between the nonionic and anionic surfactants, and the types and amounts of surfactants within the nonionic and anionic surfactant categories and are dictated by the injection water chemistry and the aforementioned reservoir conditions.

### DETAILED DESCRIPTION OF THE EMBODIMENTS

When fluid is injected into wells to cause hydraulic fracturing, some of the fluid moves into the cracks created by the fracturing process, while a part of the fluid moves into cracks and pores in the rock that are not associated with the intent of the fracturing process. Fluid efficiency is calculated as the percentage of the fluid that occupies the productive cracks. The higher the fluid efficiency, the more useful the fracturing fluid.

Fluid efficiency is not constant for a fluid. Indeed, fluid efficiency depends strongly on the type of rock in the well. The pores of different rocks respond to the electrostatic nature of the fracturing fluid differently. For example, rocks pores can by hydrophilic, hydrophobic, or neutral with respect to affinity to water. Accordingly, different fluids must be used in different rock formations to increase the fluid efficiency for the wells under study.

Throughout the present disclosure the term “about” a certain value means that a range of value±20%, and preferably a range of value±10%, is contemplated. Thus, for example, having about 20% v/v of an ingredient includes the ingredient being present between 16% and 24%, and preferably between 18% and 22%.

Disclosed herein are fracturing fluids that provide different electrostatic properties. As the result, the presently disclosed fluids provide a spectrum of fluid efficiencies for various rock formations.

The presently disclosed fluids comprise one or more surfactants along with a fermentation mixture. The fermentation mixture comprises the supernatant from the fermentation of yeast. In some embodiments, the fermentation mixture comprises about 10-70%, volume per volume (v/v) of the disclosed fluid. In other embodiments, the amount of the fermentation mixture is about 30-60% (v/v), or about 40-55% (v/v), or about 15-20% (v/v), or about 16-19% (v/v).

In some embodiments, the surfactant is nonionic or anionic, or a combination thereof. The precise mixture of the nonionic and anionic surfactants gives the disclosed fluid their specific dielectric constant that renders the surfactant mixture suitable for a particular use. In some embodiments, in addition to the above enumerated ingredients, the presently disclosed fluids comprise glycol or other alcohols as stabilizing agents.

In some embodiments, the glycol is ethylene glycol or propylene glycol. In certain embodiments, ethylene glycol and propylene glycol are used interchangeably. In other embodiments, the glycol is hexylene glycol. In still other embodiments, the glycol is butylene glycol or pentylene glycol. In some embodiments, the glycol comprises about 1-35%, volume per volume (v/v) of the disclosed fluid. In other embodiments, the amount of glycol is about 1-5% (v/v), or about 1.5-4% (v/v), or about 2-3% (v/v), or about 12-20% (v/v), or about 13-19% (v/v), or about 14-18% (v/v).

In some embodiments, the surfactant is non-ionic. In some of these embodiments, the surfactant is a mixture of ethoxylated alcohols. In some embodiments, the mixture of ethoxylated alcohols comprises about 1-35%, volume per volume (v/v) of the disclosed fluid. In other embodiments, the amount of ethoxylated alcohols is about 5-15% (v/v), or about 8-12% (v/v), or about 9-11% (v/v), or about 2-5% (v/v), or about 3-4% (v/v).

In some embodiments, the anionic surfactant is one of alkane sulfate, sodium dodecyl sulfate, or an alcohol propoxy sulfate. It is contemplated that all the sulfates comprise a counter cation that interferes either not at all or de minimis with the surfactant capabilities of the long chain molecule. An example of such counter cation is the sodium ion.

In some embodiments, the alkane sulfate comprises about 1-30%, volume per volume (v/v) of the disclosed fluid. In other embodiments, the amount of alkane sulfate is about 15-26% (v/v), or about 16-25% (v/v), or about 4-12% (v/v), or about 5-10% (v/v). In some embodiments, the sodium dodecyl sulfate comprises about 1-35%, volume per volume (v/v) of the disclosed fluid. In other embodiments, the amount of sodium dodecyl sulfate is about 1-15% (v/v), or about 2-12% (v/v), or about 4-11% (v/v). In some embodiments, the alcohol propoxy sulfate comprises about 1-35%, volume per volume (v/v) of the disclosed fluid. In other embodiments, the amount of alcohol propoxy sulfate is about 5-15% (v/v), or about 7-12% (v/v), or about 8-11% (v/v).

In some embodiments, water is added to the mixture to bring the total percentage of the ingredients to 100%. In certain embodiments, the water is deionized water, distilled water, or water purified by filtration, for example by a Millipore filter.

The following specific fluids are contemplated. All amounts are reported in volume/volume percentages. FM=Fermentation Mixture; AS=Anionic Surfactant; NS=Non-ionic Surfactant.

| | |
|---|---|
| Component | Amount |

Fluid A

| | |
|---|---|
| Hexylene glycol | 3% |
| NS | 6% |
| AS | 13% |
| FM | 26% |
| Water | 50% |
| Total | 100% |

Fluid B

| | |
|---|---|
| Glycol | 2.5% |
| NS | 10% |
| AS | 27% |
| FM | 51.5% |
| Water | 9% |
| Total | 100% |

Fluid C

| | |
|---|---|
| Glycol | 2.5% |
| NS | 10% |
| AS | 27% |
| FM | 51.5% |
| Water | 9% |
| Total | 100% |

Fluid D

| | |
|---|---|
| Glycol | 17% |
| NS | 3.5% |
| AS | 9.5% |
| FM | 18% |
| Water | 52% |
| Total | 100% |

Fluid E

| | |
|---|---|
| Glycol | 2.5% |
| AS | 33% |
| FM | 51.5% |
| Water | 13% |
| Total | 100% |

Fluid F

| | |
|---|---|
| Glycol | 2.5% |
| AS | 33% |
| FM | 51.5% |
| Water | 13% |
| Total | 100% |

1. A fluid mixture comprising:
a fermentation mixture;
a glycol;
a non-ionic and/or anionic surfactant; and
water,
wherein the fermentation mixture comprises about 10-70% (v/v) of the fluid; the glycol comprises about 1-35% (v/v) of the fluid; and the surfactant comprises about 1-70% (v/v) of the fluid.

2. The fluid mixture of claim 1, wherein the surfactant is a mixture of two or more non-ionic surfactants or anionic surfactants.

3. The fluid mixture of claim 1, wherein the fermentation mixture is about 30-60% (v/v), or about 40-55% (v/v), or about 15-20% (v/v), or about 16-19% (v/v).

4. The fluid mixture of claim 1, wherein the glycol comprises: ethylene glycol or propylene glycol or hexylene glycol.

5. The fluid mixture of claim 1, wherein the amount of glycol is about 1-5% (v/v), or about 1.5-4% (v/v), or about 2-3% (v/v), or about 12-20% (v/v), or about 13-19% (v/v), or about 14-18% (v/v).

6. The fluid mixture of claim 1, wherein the surfactant comprises a mixture of ethoxylated C9-C11 alcohols.

7. The fluid mixture of claim 1, wherein the amount of ethoxylated alcohols is about 5-15% (v/v), or about 8-12% (v/v), or about 9-11% (v/v), or about 2-5% (v/v), or about 3-4% (v/v).

8. The fluid mixture of claim 1, wherein the surfactant comprises at least one of C10-C18 alkane sulfate, sodium dodecyl sulfate, or an alcohol propoxy sulfate.

9. The fluid mixture of claim 8, wherein the alkane sulfate comprises about 1-30% (v/v), or about 15-26% (v/v), or about 16-25% (v/v), or about 4-12% (v/v), or about 5-10% (v/v).

10. The fluid mixture of claim 8, wherein the sodium dodecyl sulfate comprises about 1-35% (v/v), or about 1-15% (v/v), or about 2-12% (v/v), or about 4-11% (v/v).

11. The fluid mixture of claim 8, wherein the alcohol propoxy sulfate comprises about 1-35% (v/v), or about 5-15% (v/v), or about 7-12% (v/v), or about 8-11% (v/v).

12. The fluid mixture of claim 1, wherein water is added to the mixture to bring the total percentage of the ingredients to 100%.

13. A fluid selected from the group consisting of Fluid A, Fluid B, Fluid C, Fluid D, Fluid E, Fluid F, Fluid G, wherein each fluid comprises ingredients as described in the table below, and wherein NS=non-ionic surfactant, AS=anionic surfactant, and FM=fermentation mixture.

| | |
|---|---|
| Component | Amount |

Fluid A

| | |
|---|---|
| Hexylene glycol | 3% |
| NS | 6% |
| AS | 13% |
| FM | 26% |
| Water | 50% |
| Total | 100% |

Fluid B

| | |
|---|---|
| Glycol | 2.5% |
| NS | 10% |
| AS | 27% |
| FM | 51.5% |
| Water | 9% |
| Total | 100% |

Fluid C

| | |
|---|---|
| Glycol | 2.5% |
| NS | 10% |
| AS | 27% |
| FM | 51.5% |
| Water | 9% |
| Total | 100% |

Fluid D

| | |
|---|---|
| Glycol | 17% |
| NS | 3.5% |
| AS | 9.5% |
| FM | 18% |
| Water | 52% |
| Total | 100% |

Fluid E

| | |
|---|---|
| Glycol | 2.5% |
| AS | 33% |
| FM | 51.5% |
| Water | 13% |
| Total | 100% |

Fluid F

| | |
|---|---|
| Glycol | 2.5% |
| AS | 33% |
| FM | 51.5% |
| Water | 13% |
| Total | 100% |

14. The fluid mixture of claim 1, comprising:
at least 2.5% v/v glycol;
at least 18% v/v surfactant(s); and
at least 18% v/v fermentation mixture.

15. The fluid mixture of claim 1, comprising:
2.5% glycol;
10% non-ionic surfactant(s);
27% anionic surfactant(s); and
at least 50% fermentation mixture.
